(19) United States
(12) Patent Application Publication
(10) Pub. No.: US 2026/0350643 A1
(43) Pub. Date: Nov. 5, 2026

(54) Fee Calculation System and Fee Calculation Method

(71) Applicant: Hitachi Industrial Equipment Systems Co., Ltd., Chiyoda-ku, Tokyo (JP)

(72) Inventors: Takehiro MATSUZAKA, Tokyo (JP); Masahiko TAKANO, Tokyo (JP); Shogo OKITA, Tokyo (JP)

(21) Appl. No.: 19/113,146

(22) PCT Filed: Dec. 28, 2022
(86) PCT No.: PCT/JP2022/048550

§ 371 Date: Mar. 19, 2025

(51) Int. Cl. G06Q 30/0201; G06Q 30/0283; G06Q 50/06

(52) U.S. Cl. CPC G06Q 30/0206; G06Q 30/0283; G06Q 50/06

(57) ABSTRACT

A calculation device in a fee calculation system selects constituent equipment of a compressed gas system on the basis of a quality parameter representing the quality of gas generated by the compressed gas system, and calculates at least any expense among an initial expense of the compressed gas system, a maintenance expense in a predetermined period, and an operation expense in the predetermined period on the basis of the selected constituent equipment. The calculation device calculates a reference expense on the basis of the calculation result of the expense, and calculates a unit price of compressed gas generated by the compressed gas system, by dividing the reference expense by the amount of gas that can be supplied by the compressed gas system in a predetermined period. The calculation device calculates a usage fee of the compressed gas system on the basis of the calculated unit price of the compressed gas and the amount of use of the compressed gas, and outputs the unit price of the compressed gas and the usage fee of the compressed gas system.

### TECHNICAL FIELD

The present invention relates to a fee calculation system and a fee calculation method.

### BACKGROUND ART

Conventionally, a gas compressor such as an air compressor that generates compressed gas is known. Patent Document 1 describes an evaluation device for a fluid machine such as a gas compressor purchased by a customer as a customer's own asset, the evaluation device evaluating selection of a machine type and an installation position and a maintenance plan regarding the fluid machine.

### PRIOR ART DOCUMENT

### Patent Document

Patent Document 1: JP-2022-45744-A

### SUMMARY OF THE INVENTION

### Problem to be Solved by the Invention

There exists a pay-per-use service in which a gas compressor is provided to a customer in the form of lease, rental, or the like and a fee is received from the customer depending on the time for which the gas compressor is used or the utilization rate. Further, there also exists a flat-rate usage (subscription) service in which a gas compressor is lent to a customer for a certain period and a fixed amount is paid to a service provider irrespective of the operation time or the utilization rate of the gas compressor. In the pay-per-use service and the flat-rate usage service, the fee per unit gas amount, i.e., the gas unit price, needs to be decided in consideration of the quality of gas such as compressed air requested by the customer. The evaluation device described in Patent Document 1 is based on the premise that the customer directly bears the electricity cost of power consumption and the maintenance cost regarding a gas compressor, and thus cannot be used for the decision of the gas unit price in the pay-per-use service and the flat-rate usage service.

The present invention intends to provide a fee calculation system and a fee calculation method that can decide a gas unit price in consideration of the quality of gas.

### Means for Solving the Problem

A fee calculation system according to one aspect of the present invention is a fee calculation system including a calculation device that calculates a usage fee of a compressed gas system. The calculation device is configured to acquire a quality parameter representing the quality of gas generated by the compressed gas system, and select constituent equipment of the compressed gas system on the basis of the acquired quality parameter. The calculation device is configured to calculate at least any expense among an initial expense of the compressed gas system, a maintenance expense in a predetermined period, and an operation expense in the predetermined period on the basis of the selected constituent equipment, calculate a reference expense on the basis of a calculation result of the expense, and calculate a unit price of compressed gas generated by the compressed gas system, by dividing the reference expense by the amount of gas that can be supplied by the compressed gas system in a predetermined period. The calculation device is configured to calculate a usage fee of the compressed gas system on the basis of the calculated unit price of the compressed gas and the amount of use of the compressed gas, and output the calculated unit price of the compressed gas and the calculated usage fee of the compressed gas system.

### Advantages of the Invention

According to the present invention, it is possible to provide a fee calculation system and a fee calculation method that can decide a gas unit price in consideration of the quality of gas.

### BRIEF DESCRIPTION OF THE DRAWINGS

FIG. 1 is a schematic diagram depicting an overall configuration of a system that calculates the usage fee of compressed air.

FIG. 2 is a block diagram schematically depicting a hardware configuration of a fee calculation system.

FIG. 3 is a schematic diagram depicting a configuration of a compressed air system.

FIG. 4 is a schematic diagram depicting a functional configuration of the fee calculation system.

FIG. 5 is a diagram depicting a data configuration example of input data.

FIG. 6 is a schematic diagram depicting a configuration example of an air compressor database.

FIG. 7 is a schematic diagram depicting a configuration example of a filter (air filter) database.

FIG. 8 is a schematic diagram depicting a configuration example of a dryer (dehumidifying device) database.

FIG. 9 is a schematic diagram depicting a configuration example of an air reservoir database.

FIG. 10 is a diagram depicting a data configuration example of output data.

FIG. 11 is a flowchart of fee calculation processing executed by a calculation device.

FIG. 12 is a schematic diagram depicting a configuration of a compressed air system according to a second embodiment.

FIG. 13 is a schematic diagram depicting a configuration of a compressed air system according to a third embodiment.

FIG. 14 is a schematic diagram depicting a configuration example of an exhaust heat recovery device database.

### MODES FOR CARRYING OUT THE INVENTION

### First Embodiment

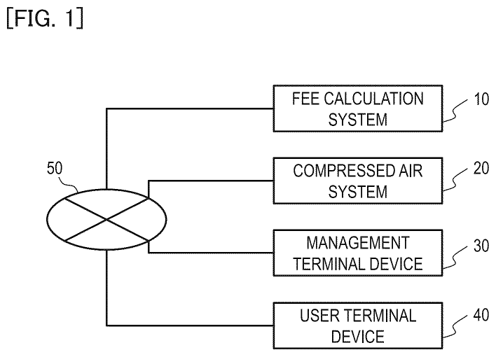

A fee calculation system according to a first embodiment of the present invention is described with reference to FIGS. 1 to 11.

FIG. 1 is a schematic diagram depicting an overall configuration of a system that calculates a usage fee of compressed air. A fee calculation system 10 has a function of calculating the usage fee of a compressed air system 20. The fee calculation system 10 and the compressed air system 20 are connected to a network 50 in a wired or wireless manner. The fee calculation system 10 and the compressed air system 20 are configured to be capable of establishing bidirectional data communication through the network 50. A management terminal device 30 and a user terminal device 40 are further connected to the network 50. The management terminal device 30 is a terminal device operated by a manager or an operator of the fee calculation system 10 or the compressed air system 20. The user terminal device 40 is a terminal device operated by a user of the fee calculation system 10 or the compressed air system 20. In the following description, the management terminal device 30 and the user terminal device 40 are collectively referred to as the terminal device.

The terminal device includes a display device (for example, liquid crystal monitor) that is not depicted. By operating the terminal device, the manager, the operator, and the user of the fee calculation system 10 can input (transmit) input data to be described later to the fee calculation system 10, and can receive output data to be described later from the fee calculation system 10 and display the output data on the display device. Moreover, the manager and the like can display, for example, an operation state, a past operation history, and the like of the compressed air system 20 on the display device by operating the terminal device. It is to be noted that the fee calculation system 10 may be provided with a display device and the display device may display similar information.

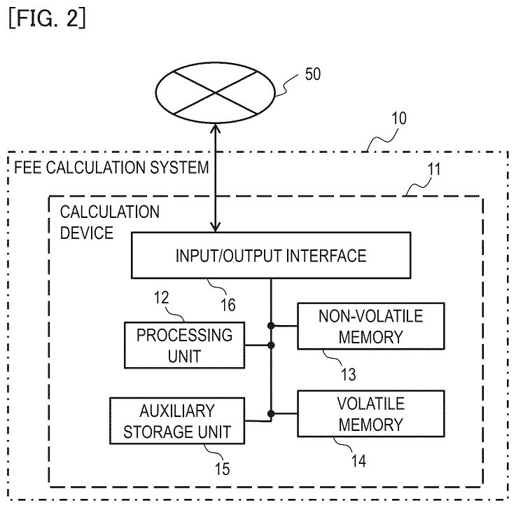

FIG. 2 is a block diagram schematically depicting a hardware configuration of the fee calculation system 10. The fee calculation system 10 includes a calculation device 11.

The calculation device 11 is configured by a computer including a processing unit 12 such as a CPU (Central Processing Unit), an MPU (Micro Processing Unit), or a DSP (Digital Signal Processor), a non-volatile memory 13 such as a ROM (Read Only Memory), a flash memory, or a hard disk drive, a volatile memory 14 generally referred to as a RAM (Random Access Memory), an auxiliary storage unit 15 such as an HDD (Hard Disk Drive) or an SSD (Solid State Drive), an input/output interface 16, and other peripheral circuits.

These pieces of hardware cooperate to operate software and implement a plurality of functions. It is to be noted that the calculation device 11 may be configured by one computer or be configured by a plurality of computers. Further, an ASIC (application specific integrated circuit), an FPGA (Field Programmable Gate Array), or the like can be used as the processing unit 12.

A program that can execute various computations is stored in the non-volatile memory 13. That is, the non-volatile memory 13 is a storage medium (storage device) that can read a program for implementing functions of the present embodiment. The volatile memory 14 is a storage medium (storage device) that temporarily stores a result of a computation by the processing unit 12 and a signal input from the input/output interface 16. The auxiliary storage unit 15 is a storage medium (storage device) that stores a plurality of databases to be described later. The processing unit 12 is a unit that loads the program stored in the non-volatile memory 13 into the volatile memory 14 and executes computation, and executes predetermined computation processing for data taken in from the input/output interface 16, the non-volatile memory 13, the volatile memory 14, and the auxiliary storage unit 15 in accordance with the program.

An input section of the input/output interface 16 converts a signal input from the network 50 to data for which computation by the processing unit 12 is possible. An output section of the input/output interface 16 generates a signal for output according to the result of the computation in the processing unit 12 and outputs the signal to the network 50.

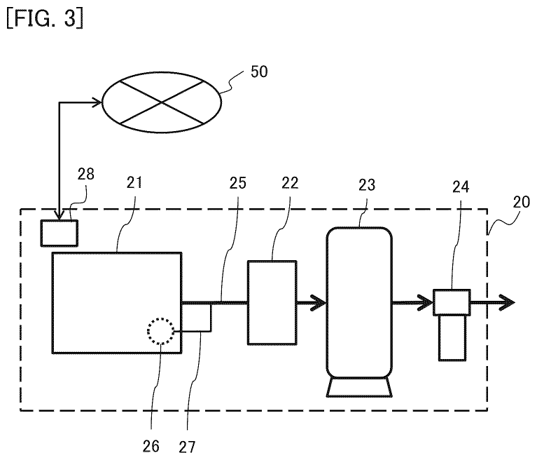

FIG. 3 is a schematic diagram depicting a configuration of the compressed air system 20 according to the first embodiment. The compressed air system 20 includes an air compressor 21, a dryer 22, an air reservoir 23, and a filter 24. These respective units are mutually connected by an air pipe 25. A pressure sensor 26 is disposed inside the air compressor 21. The pressure sensor 26 and the air pipe 25 are caused to communicate with each other by a pressure sensing pipe 27. The air pressure sensed by the pressure sensor 26 is used for controlling operation of the air compressor 21.

The air compressor 21 sucks air from the surrounding atmosphere and compresses the air. The air compressor 21 cools the compressed air after separating oil from the compressed air, and causes the compressed air to flow out to the air pipe 25. The dryer 22 dries the compressed air that has flown out from the air compressor 21. For example, the dryer 22 dries the compressed air by cooling the compressed air to condense water vapor contained in the compressed air and separating the water vapor from the compressed air. The compressed air dried by the dryer 22 is sent to the air reservoir 23. The air reservoir 23 temporarily accumulates therein the compressed air. The compressed air accumulated in the air reservoir 23 is sent out to a demand destination after minute dust remaining in the compressed air is removed by the filter 24.

Further, the compressed air system 20 includes a communication device 28 for executing communication with each of the fee calculation system 10, the management terminal device 30, and the user terminal device 40 through the network 50. The communication device 28 is connected to the network 50 in a wired or wireless manner.

As described in detail later, a plurality of equipment types exist regarding the air compressor 21 in the present embodiment. Characteristics of the compressed air system 20, such as the quality, the air amount, and the cost, change depending on which equipment type of air compressor 21 is incorporated into the compressed air system 20. The same applies to the dryer 22, the air reservoir 23, and the filter 24. In the following description, the air compressor 21, the dryer 22, the air reservoir 23, and the filter 24 are collectively referred to as the fluid equipment.

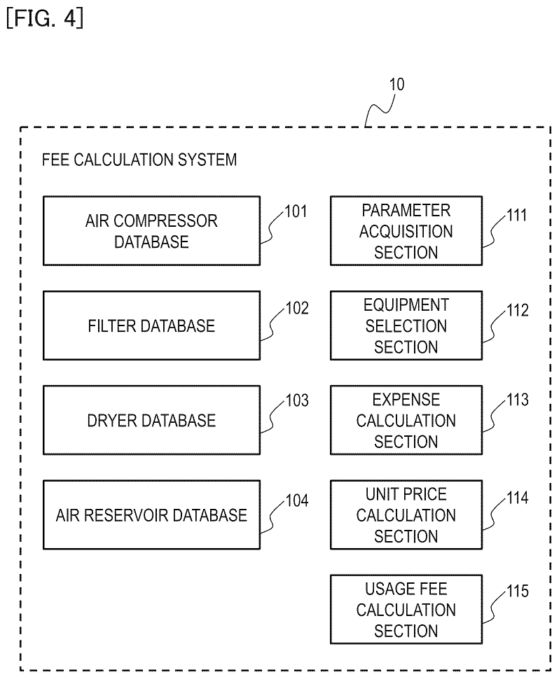

FIG. 4 is a schematic diagram depicting a functional configuration of the fee calculation system 10. The fee calculation system 10 includes an air compressor database 101, a filter database 102, a dryer database 103, an air reservoir database 104, a parameter acquisition section 111, an equipment selection section 112, an expense calculation section 113, a unit price calculation section 114, and a usage fee calculation section 115. The air compressor database 101, the filter database 102, the dryer database 103, and the air reservoir database 104 are stored in the auxiliary storage unit 15 depicted in FIG. 2. The parameter acquisition section 111, the equipment selection section 112, the expense calculation section 113, the unit price calculation section 114, and the usage fee calculation section 115 are implemented by the processing unit 12 reading and executing a program stored in the non-volatile memory 13.

The parameter acquisition section 111 acquires quality parameters representing the quality of compressed air from the terminal device. The equipment selection section 112 selects pieces of constituent equipment (equipment types) of the air compressor 21 on the basis of the quality parameters acquired by the parameter acquisition section 111. The expense calculation section 113 calculates an initial expense of the compressed air system 20 and a maintenance expense and an operation expense in a predetermined period on the basis of the pieces of constituent equipment selected by the equipment selection section 112. The expense calculation section 113 calculates a reference expense (base cost) on the basis of the calculation results of the initial expense, the maintenance expense, and the operation expense. The unit price calculation section 114 calculates a unit price of compressed air generated by the compressed air system 20, by dividing the reference expense calculated by the expense calculation section 113 by the amount of air that can be supplied by the compressed air system 20 in a predetermined period. The usage fee calculation section 115 calculates a usage fee of the compressed air system 20 on the basis of the unit price of the compressed air calculated by the unit price calculation section 114 and the amount of use of the compressed air by the user.

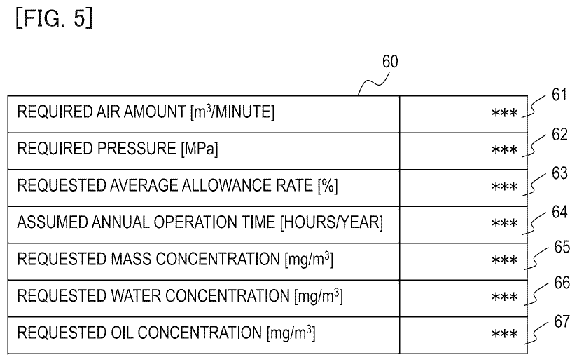

FIG. 5 is a diagram depicting a data configuration example of input data 60. The input data 60 is input from the terminal device 30 or 40 to the fee calculation system 10 through the network 50. The input data 60 input to the fee calculation system 10 is stored in the volatile memory 14 or the auxiliary storage unit 15 depicted in FIG. 2. The input data 60 includes conditions that the compressed air system 20 is requested to meet by the user. For example, the input data 60 includes quality parameters representing the quality of the compressed air generated by the compressed air system 20.

The input data 60 includes a required air amount 61, a required pressure 62, a requested average allowance rate 63, an assumed annual operation time 64, a requested mass concentration 65, a requested water concentration 66, and a requested oil concentration 67. The required air amount 61 is a value [m³/minute] indicating the amount of compressed air required by the user. The required pressure 62 is a value [MPaG] indicating the pressure of compressed air required by the user. The requested average allowance rate 63 is a value [%] for adjusting how much allowance the amount of compressed air that can be supplied to the user by the compressed air system 20 (i.e., rated air amount of the compressed air system 20) is allowed to have with respect to the required air amount 61. When an average load rate of an air compressor used in general is defined as R, the requested average allowance rate 63 is represented by the following formula (1).

Requested average allowance rate=(100−R) [%] (1)

It is to be noted that the average load rate R is represented by the following formula (2).

Average load rate R=(Required air amount/Rated air amount)×100 [%] (2)

The assumed annual operation time 64 is an assumed value [hours/year] of the time per year for which the user operates the compressed air system 20.

The requested mass concentration 65, the requested water concentration 66, and the requested oil concentration 67 are values (quality parameters) indicating the quality that the compressed air is requested to satisfy by the user. The requested mass concentration 65 is a value [mg/m³] indicating the mass concentration of foreign matters such as dust permitted for the compressed air required by the user. The requested water concentration 66 is a parameter representing the water amount per unit air amount and, in the present embodiment, is a value [mg/m³] indicating the water concentration permitted for the compressed air required by the user. The requested oil concentration 67 is a value [mg/m³] indicating the oil total concentration permitted for the compressed air required by the user. It is to be noted that the “oil total concentration” in this case is the oil total concentration including liquid oil, oil vapor, and vapor of an organic solvent and includes, for example, a polymer of hydrocarbon such as acetone.

It is to be noted that, as the requested air quality, the maximum number of particles per 1 m³ corresponding to the particle size (μm) (i.e., the number of particles of foreign manners per unit air amount) may be used instead of the requested mass concentration 65. Further, instead of the requested mass concentration 65, a value selected from classes 0, 1, . . . , 7, and X (not defined) set in advance in JIS B 8392-1: 2012 (ISO 8573-1: 2010) and the like may be employed. Here, when the number of the class is smaller, the quality is higher, in other words, the number of particles and the mass concentration regarding contained dust and the like are smaller.

Similarly, as the quality of the humidity or the water concentration (i.e., parameter representing the water amount per unit air amount), a requested dewpoint [°C PDP] may be used instead of the requested water concentration 66. For example, a requested pressure dewpoint or a requested atmospheric dewpoint may be used. Moreover, instead of the requested water concentration 66, a value selected from classes 0, 1, . . . , 9, and X (not defined) set in advance in JIS B 8392-1: 2012 (ISO 8573-1: 2010) and the like may be employed. Here, when the number of the class is smaller, the dewpoint is lower, and the water concentration is lower.

Similarly, as the quality of the oil total concentration, a value selected from classes 0, 1, . . . , 4, and X (not defined) set in advance in JIS B 8392-1: 2012 (ISO 8573-1: 2010) and the like may be employed instead of the requested oil concentration 67. Here, the oil total concentration in the compressed air is lower when the number of the class is smaller.

If there is an item without specially requested quality in the air quality, this item may be treated as an item to which an initial value of general quality that is set in advance is input. For example, if the user does not make a particular request regarding the quality of the humidity or the water concentration, a value that is set in advance may be treated as the value of the requested water concentration 66.

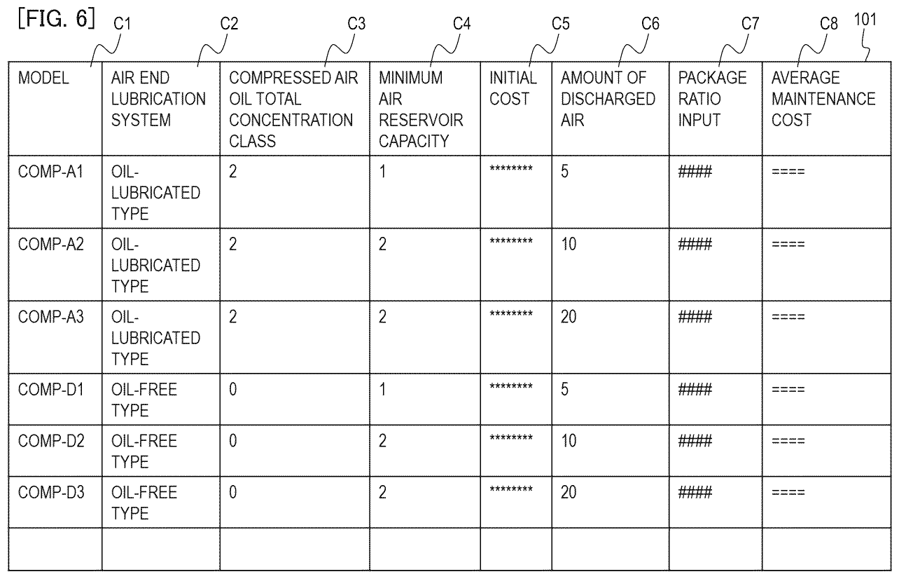

FIG. 6 is a schematic diagram depicting a configuration example of the air compressor database 101. The air compressor database 101 stores information regarding a compressor model C1, an air end lubrication system C2 corresponding to it, a compressed air oil total concentration class C3 that can be achieved, the minimum air reservoir capacity C4, an initial cost C5, the amount of discharged air C6, a package ratio input C7, and an average maintenance cost C8. The compressor model C1 functions as a fluid equipment model identifier to identify the model (equipment type) of the air compressor 21.

The compressed air oil total concentration class C3 is the compressed air oil total concentration class that can be achieved by the air compressor. The package ratio input C7 is a value [kW/(m³/hour)] of power required to output a predetermined amount (for example, 1 m³) of compressed air in a predetermined time (for example, one hour), and is calculated by dividing the rated power by the amount of discharged air.

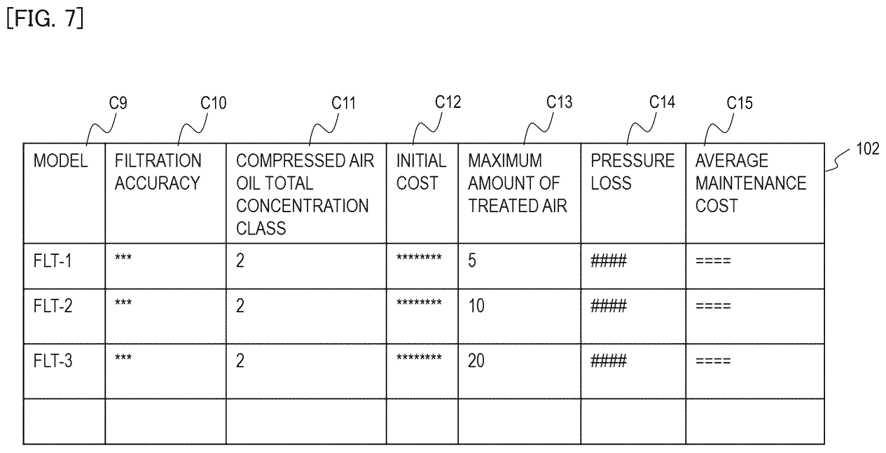

FIG. 7 is a schematic diagram depicting a configuration example of the filter (air filter) database 102. The filter database 102 stores information regarding a filter model C9, a filtration accuracy C10 corresponding to it, a compressed air oil total concentration class C11, an initial cost C12, the maximum amount of treated air C13, a pressure loss C14 at the time of the maximum amount of treated air, and an average maintenance cost C15. The filter model C9 functions as a fluid equipment model identifier to identify the model (equipment type) of the filter 24. The filtration accuracy C10 is the filtration accuracy that can be achieved by the filter, and corresponds to the quality of the number of particles of dust and the like. As the filtration accuracy C10, for example, an index such as “90% of particles with a diameter of 5 um or larger can be removed” can be used. The compressed air oil total concentration class C11 is the compressed air oil total concentration class that can be achieved by the filter. The maximum amount of treated air C13 is a value [m³/hour] of the maximum amount of compressed air that can be treated per unit time (for example, one hour).

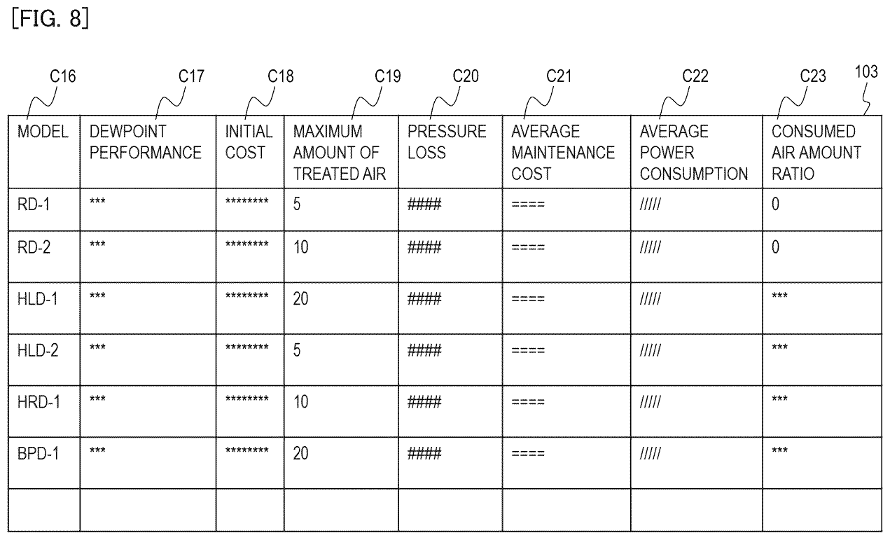

FIG. 8 is a schematic diagram depicting a configuration example of the dryer (dehumidifying device) database 103. The dryer database 103 stores information regarding a dryer model C16, a dewpoint performance C17 corresponding to it, an initial cost C18, the maximum amount of treated air C19, a pressure loss C20 at the time of the maximum amount of treated air, an average maintenance cost C21, an average power consumption C22, and a consumed air amount ratio C23. The dryer model C16 functions as a fluid equipment model identifier to identify the model (equipment type) of the dryer 22. The dewpoint performance C17 corresponds to the quality of the humidity or the water concentration achieved by the dryer. The maximum amount of treated air C19 indicates an inlet air amount of the dryer. The average power consumption C22 is used to particularly represent an average power consumption through adsorption, regeneration, and cooling processes of a heat regenerative dryer, and specifically is a power consumption of a heater, a blower, or both of them mounted in the heat regenerative dryer. The consumed air amount ratio C23 is information that exists because part of compressed air that flows in is consumed in some cases depending on the kind of dryer. For example, in a heatless dryer, approximately 15% of the inlet air amount of the dryer is consumed at the time of regeneration of an adsorbent inside the dryer. Even with a heat regenerative dryer, approximately 8% is consumed. Thus, the amount of dry compressed air that can be supplied to a demand destination becomes smaller by the amount of consumed air, and the running cost of the system is affected.

Meanwhile, the consumed air amount ratio C23 becomes 0 in the case of a refrigeration dryer. For example, in FIG. 8, dryers regarding which “RD-1” and “RD-2” are set as the dryer model C16 are refrigeration dryers, and the consumed air amount ratio C23 corresponding to them is 0.

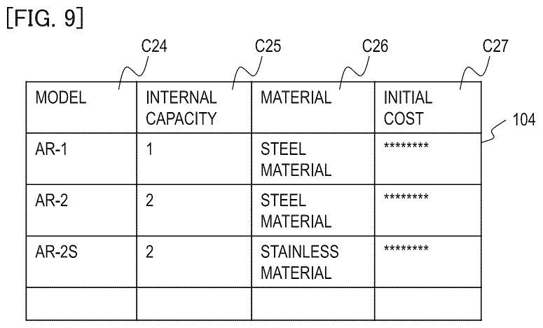

FIG. 9 is a schematic diagram depicting a configuration example of the air reservoir database 104. The air reservoir database 104 stores information regarding an air reservoir model C24, an air reservoir internal capacity C25 corresponding to it, a material C26, and an initial cost C27.

The air reservoir model C24 functions as a fluid equipment model identifier to identify the model (equipment type) of the air reservoir 23.

The equipment selection section 112 depicted in FIG. 4 searches the respective databases 101 to 104 for a combination of pieces of fluid equipment that satisfy requested input values (quality parameters) on the basis of the respective input values (quality parameters) in the input data, and temporarily saves the search result in the volatile memory 14. It is to be noted that, in a case in which a plurality of combinations exist as the combination of pieces of fluid equipment that satisfy requested input values (quality parameters), one of the combinations may be selected and saved, or all of the combinations may be saved.

The equipment selection section 112 is configured to be capable of temporarily saving different search results based on a plurality of different input values in the volatile memory 14. This allows comparison of the search results among the different input values.

The expense calculation section 113 calculates the initial expense of the compressed air system 20, the maintenance expense in a predetermined period, the operation expense in the predetermined period, and the like on the basis of the pieces of constituent equipment selected by the equipment selection section 112 (search result temporarily saved in the volatile memory 14). The expense calculation section 113 calculates the reference expense on the basis of the calculation results of them. The unit price calculation section 114 calculates the unit price of compressed air generated by the compressed air system 20, by dividing the reference expense calculated by the expense calculation section 113 by the amount of air that can be supplied by the compressed air system 20 in a predetermined period.

The usage fee calculation section 115 calculates the usage fee of the compressed air system 20 on the basis of the unit price of the compressed air calculated by the unit price calculation section 114 and the amount of use of the compressed air by the user. The calculated result is temporarily saved in the volatile memory 14 as output data.

The output data is output to the terminal device through the network 50. For example, the terminal device displays the output data that has been output by the fee calculation system 10 and been input to the terminal device, on a display device such as a liquid crystal monitor, or outputs the output data to an output device such as a printer, or stores the output data in a storage device such as an HDD.

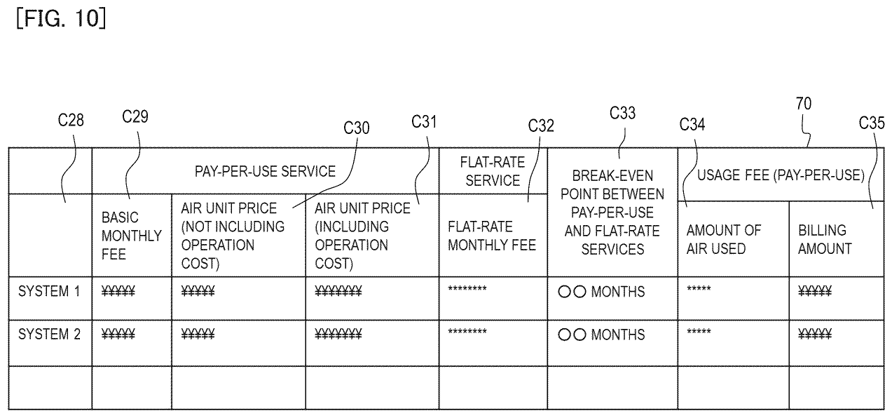

FIG. 10 is a diagram depicting a data configuration example of the output data. Output data 70 depicted in FIG. 10 includes, as one example, calculation results of the usage fee of system 1 and system 2 corresponding to pieces of input data different from each other. The output data 70 includes information regarding a system identifier C28 corresponding to each piece of input data, a basic monthly fee C29 corresponding to it, an air unit price C30 that does not include the operation cost, an air unit price C31 including the operation cost, a flat-rate monthly fee C32, a break-even point C33, the amount of air used C34, and a billing amount C35. The basic monthly fee C29 is a basic fee per month in a pay-per-use service. It is to be noted that the basic fee per year or per predetermined period other than that may be employed instead of the basic fee per month. The air unit price C30 that does not include the operation cost is an air unit price employed when, for example, the power consumption fee is not included (user oneself bears the power consumption fee). The air unit price C31 including the operation cost is an air unit price employed when, for example, the power consumption fee is included (user oneself does not bear the power consumption fee).

The expense calculation section 113 depicted in FIG. 4 calculates the reference expense by the following formula (3).

Reference expense=>ΣIn+ΣMn+ΣFn+ΣOn (3)

Here, ΣIn is the sum of the initial costs of the respective pieces of fluid equipment selected by the equipment selection section 112. ΣMn is the sum of the average maintenance costs of the same. ΣOn is the sum of the operation costs. ΣFn is the sum of other fixed expenses incurred, such as a management expense and tax. It is to be noted that examples of the operation cost include the power consumption fee when the air compressor 21 is driven by a motor. Further, a fuel expense of light oil, gasoline, and the like is given as the operation cost when the air compressor 21 is driven by an internal combustion engine.

The unit price calculation section 114 calculates the air unit price by the following formula (4).

Air unit price=Reference expense/(Q×He) (4)

Here, Q is a system air amount, and He is an assumed operation time. That is, (Q×He) represents the amount of air that can be supplied by the compressed air system 20 in a predetermined period. As above, the unit price calculation section 114 calculates the unit price of compressed air generated by the compressed air system 20, by dividing the reference expense calculated by the expense calculation section 113 by the amount of air (Q×He) that can be supplied by the compressed air system 20 in the predetermined period.

In general, when the requested air amount is larger, the compressor output power (the amount of compressed air output by the compressed air system per unit time) becomes higher, and the requested air quality is higher. It can be said that the air quality is higher when the number of particles or the mass concentration regarding foreign matters such as dust is lower, when the humidity or the water concentration is lower, and when the oil total concentration including liquid oil and oil vapor is lower (class 0 is the highest quality regarding all concentrations). When the requested air quality is higher, the compatible fluid equipment becomes more expensive, and thus the air unit price also becomes higher.

In the case in which a user bears the electricity fee incurred when the compressed air system 20 is used in a pay-per-use service, it is desirable that the power consumption fee is excluded from the billing amount of the compressed air usage fee charged to the user. The expense calculation section 113 calculates the reference expense in this case by the following formula (5).

Reference expense=α1×(ΣIn+ΣMn+ΣFn) (5)

Here, α1 is a weighting factor that can be set to any value for money amount adjustment.

The unit price calculation section 114 calculates the air unit price C30 by the following formula (6).

Air unit price=Reference expense/(Qe×He) (6)

Here, Qe is the amount of air per unit time decided at the timing when the user has contracted with this pay-per-use service. That is, (Qe×He) represents the amount of air anticipated to be consumed in a predetermined period (the anticipated system-air-amount Ae).

The unit price calculation section 114 sets a predetermined threshold Ae0 for the anticipated system-air-amount Ae. When the amount of air actually used by the user (the amount of system air used Qc) exceeds the threshold Ae0 of the anticipated system-air-amount Ae, the unit price calculation section 114 sets a value larger than the anticipated system-air-amount Ae at the time of the contraction, as a new anticipated system-air-amount Ae′. The unit price calculation section 114 recalculates the air unit price on the basis of the anticipated system-air-amount Ae′ newly set. This can implement billing of an appropriate usage fee of the compressed air.

The amount of system air used Qc is calculated by the following formula (7).

Qc=Qe×Ra (7)

Here, Ra is a real average load rate in a predetermined period.

Specifically, the real average load rate Ra is an actual average load rate of the compressed air system 20 in a billing period of the compressed air usage fee, and is calculated by, for example, the following formula (8).

Ra=(ΣR)/Ha (8)

Here, Ha is a real operation time. The real operation time Ha is an actual operation time of the compressed air system 20 in the billing period of the compressed air usage fee. R is an average load rate per unit time.

The average load rate R is calculated by the following formula (9).

R={αp×αf×(T1/ (T1+T2))} (9)

Here, αp is a pressure coefficient. αf is an output frequency coefficient. T1 is a load operation time. T2 is a no-load operation time.

The pressure coefficient ap represents the ratio of the power consumption at the time of a pressure set by the user to the power consumption at a specification pressure of the air compressor 21 selected. For example, when the air compressor 21 with a specification pressure of 0.7 MPaG is selected and a working pressure set by the user is also 0.7 MPaG, the pressure coefficient op is 1.0(100 %). The output frequency coefficient of represents the ratio of an average output frequency per unit time at which the air compressor 21 is operated to the maximum output frequency of a motor of the air compressor 21 selected. For example, when the maximum rotation speed of the air compressor 21 selected is 60 Hz and the average output frequency per unit time at which the air compressor 21 is operated is also 60 Hz, the output frequency coefficient αf is 1.0(100 %). The load operation time T1, the no-load operation time T2, a user setting pressure Pd for obtaining the pressure coefficient αp, and an average output frequency fa per unit time for obtaining the output frequency coefficient of are transmitted from the compressed air system 20 to the fee calculation system 10 through the network 50.

On the other hand, in the case in which a user does not bear the power consumption fee incurred when the compressed air system is used in a pay-per-use service, that is, in the case in which the provider of this service or a third party other than that bears the electricity fee, an amount corresponding to the power consumption fee may be included in the billing amount of the compressed air usage fee charged to the user. The air unit price C31 in this case can be calculated by the following formula (10).

Air unit price=α2×(ΣIn+ΣMn+ΣFn+ΣOn)/(Qc×Ha) (10)

The denominator of this calculation formula is represented by the product of the amount of system air used Qc actually used by the user and the real operation time Ha. A billing amount Cb charged to the user at this time is the product of the amount of system air used Qc and the air unit price 31. A weighting factor α2 is a coefficient that can be set to any value for money amount adjustment. In this case, it is sufficient for the user to pay for the billing corresponding to the net amount of compressed air used. Thus, the payment amount is suppressed when the amount of system air used per predetermined period is small.

The flat-rate monthly fee C32 is the fee per month when a flat-rate (subscription) service in which the fee is fixed irrespective of the track record of use is used. It is to be noted that the flat-rate fee per year or per predetermined period other than that may be employed instead of the flat-rate fee per month. The break-even point C33 is the minimum period (the number of months or the number of years) in which the flat-rate service is more advantageous (yields smaller payment amount) than the pay-per-use service. By including the break-even point C33 in the output data 70, an estimate regarding each combination of pieces of fluid equipment can be easily presented to the user. Further, the user can easily determine where an advantage exists regarding each set of multiple input values.

The amount of air used C34 and the billing amount C35 are information for the user who is already using the pay-per-use service, and indicate latest past track record values. Here, as the amount of system air used Qc, a value obtained by actual measurement by a flow rate sensor or the like is used. Alternatively, the product of the amount of air Qe per unit time decided at the time of the contraction and the real average load rate Ra in a predetermined period (=Qe×Ra) is used. That is, the amount of use of the compressed air may be calculated on the basis of a measurement value of the flow rate sensor disposed on a flow path of the compressed air, or may be calculated on the basis of the load rate of the air compressor 21 included in the compressed air system 20. By estimating the amount of system air used Qc by using the real average load rate Ra in the predetermined period transmitted from the air compressor 21, the need for costs such as the expense of the flow rate sensor main unit and the expense of attachment work thereof is eliminated, and the pay-per-use service can be provided at a lower cost.

Whether to include the average maintenance cost ΣMn in the billing of the compressed air usage fee in the pay-per-use service can be decided as desired according to the demand of the customer. When the customer desires to manage and bear the maintenance cost at customer's own risk, the average maintenance cost ΣMn may be excluded from the air unit price C30 or the air unit price C31. On the other hand, when the customer has a demand to ensure stable operation of the compressed air system by leaving periodic execution of maintenance to the service provider, the maintenance cost may be included in the pay-per-use amount. That is, as described above, the average maintenance cost ΣMn may be taken into consideration in calculation of the air unit price as indicated by the calculation formulas of the air unit price C30 and the air unit price C31. By adding or excluding each cost in the calculation formula of the air unit price as desired, contents of service flexibly responding to the demand of the customer can be presented.

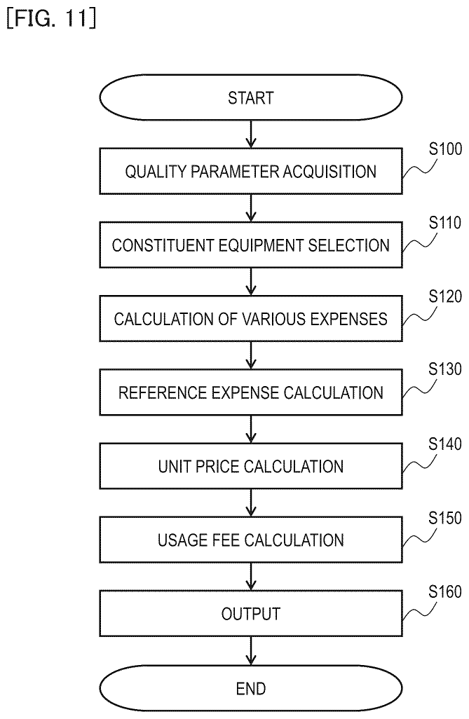

FIG. 11 is a flowchart of fee calculation processing executed by the calculation device 11. In a step S100, the parameter acquisition section 111 acquires the quality parameters representing the quality of compressed air generated by the compressed air system 20. In a step S110, the equipment selection section 112 selects pieces of constituent equipment of the compressed air system 20 on the basis of the quality parameters acquired in the step S100. In a step S120, the expense calculation section 113 calculates the initial expense of the compressed air system, the maintenance expense in a predetermined period, and the operation expense in the predetermined period on the basis of the pieces of constituent equipment selected in the step S110. In a step S130, the expense calculation section 113 calculates the reference expense on the basis of the calculation results in the step S120. In a step S140, the unit price calculation section 114 calculates the unit price of the compressed air generated by the compressed air system 20, by dividing the reference expense calculated in the step S130 by the amount of compressed air that can be supplied by the compressed air system 20 in a predetermined period. In a step S150, the usage fee calculation section 115 calculates the usage fee of the compressed air system 20 on the basis of the unit price of the compressed air calculated in the step S140 and the amount of use of the compressed air by the user. In a step S160, the usage fee calculation section 115 outputs (transmits), to the terminal device, the output data 70 including the unit price of the compressed air calculated in the step S140 and the usage fee of the compressed air system 20 calculated in the step S150.

The present first embodiment provides the following operation and effects.

(1) The calculation device 11 acquires the quality parameters (for example, the requested mass concentration 65, the requested water concentration 66, and the requested oil concentration 67) representing the quality of gas generated by the compressed air system 20 (compressed gas system). The calculation device 11 selects pieces of constituent equipment of the compressed air system 20 (compressed gas system) on the basis of the acquired quality parameters, and calculates the initial expense of the compressed air system 20 (compressed gas system), the maintenance expense in a predetermined period, and the operation expense in the predetermined period on the basis of the selected pieces of constituent equipment. In addition, the calculation device 11 calculates the reference expense on the basis of the calculation results of the expenses. The calculation device 11 calculates the unit price of compressed air (compressed gas) generated by the compressed air system 20 (compressed gas system), by dividing the reference expense by the amount of air (the amount of gas) that can be supplied by the compressed air system 20 (compressed gas system) in a predetermined period. The calculation device 11 calculates the usage fee of the compressed air system 20 (compressed gas system) on the basis of the calculated unit price of the compressed air (compressed gas) and the amount of use of the compressed air (compressed gas). The calculation device 11 outputs the calculated unit price of the compressed air (compressed gas) and the calculated usage fee of the compressed air system 20 (compressed gas system). Because this configuration is employed, the fee calculation system that can decide the gas unit price in consideration of the quality of the gas can be provided.
(2) The calculation device 11 acquires, as the quality parameters, the requested mass concentration 65 (mass concentration of foreign matters), the requested water concentration 66 (parameter representing the water amount per unit gas amount), and the requested oil concentration 67 (oil total concentration). Because this configuration is employed, the fee calculation system that can decide the air unit price (gas unit price) while considering the quality of the compressed air from various perspectives can be provided.
(3) In the case in which the calculation device 11 calculates the amount of use of the compressed air (compressed gas) on the basis of a measurement value of a flow rate sensor disposed on a flow path of the compressed air (compressed gas), the usage fee can be calculated on the basis of the accurate amount of use.
(4) In the case in which the calculation device 11 calculates the amount of use of the compressed air (compressed gas) on the basis of the load rate of the air compressor 21 (gas compressor) included in the compressed air system 20 (compressed gas system), costs such as the expense of the flow rate sensor main unit and the expense of attachment work thereof become unnecessary, and a pay-per-use service can be provided at a lower cost.
(5) The calculation device 11 outputs the unit price of the compressed air (compressed gas) and the usage fee of the compressed air system 20 (compressed gas system) to a display device or the terminal device (terminal) including the display device, and causes the display device to display the unit price of the compressed air (compressed gas) and the usage fee of the compressed air system 20 (compressed gas system).

Because this configuration is employed, the user can easily check the unit price and the usage fee.

### Second Embodiment

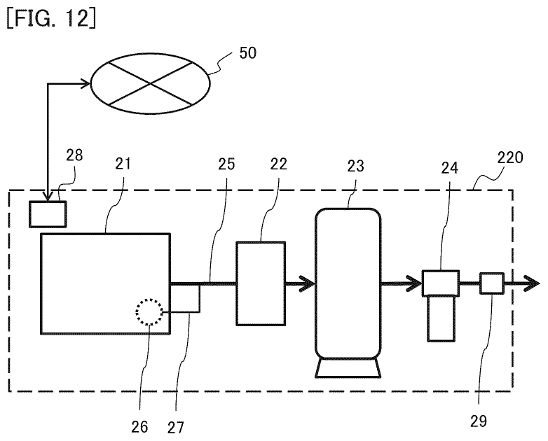

A fee calculation system according to a second embodiment of the present invention is described with reference to FIG. 12. It is to be noted that a configuration that is the same as or equivalent to a configuration described in the first embodiment is given the same reference character, and differences are mainly described.

FIG. 12 is a diagram similar to FIG. 3 and is a schematic diagram depicting a configuration of a compressed air system 220 according to the second embodiment. In the compressed air system 220 according to the present embodiment, a flow rate sensor 29 is installed on the downstream side relative to the filter 24, that is, immediately before an air demand destination of a user that is not depicted. Making this configuration allows actual measurement of the amount of system air used Qc actually used by the user.

The present second embodiment provides the following operation and effect.

(1) The flow rate sensor 29 is installed on the downstream side relative to the filter 24, that is, immediately before an air demand destination of a user that is not depicted. This makes it possible to use, for calculation of the billing amount, a more accurate air amount obtained in consideration of also the amount of variation in the volume of the compressed air due to change in the temperature of the surrounding atmosphere or change in the atmospheric pressure.

### Third Embodiment

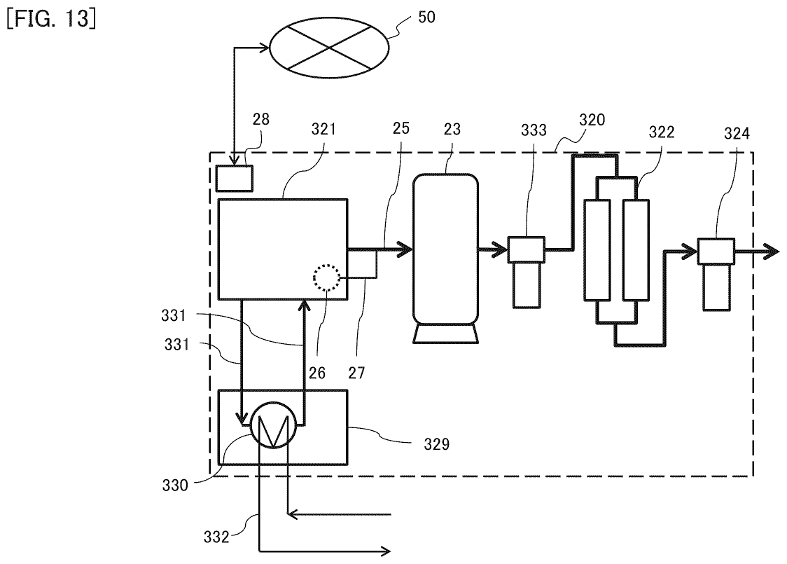

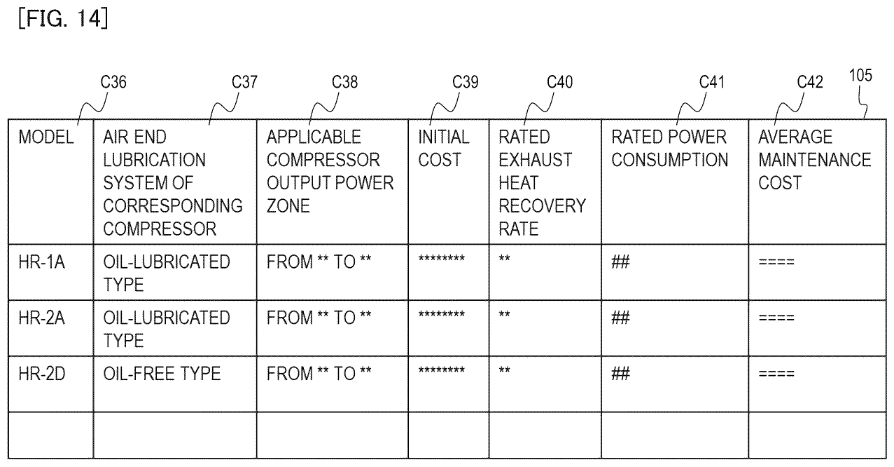

A fee calculation system according to a third embodiment of the present invention is described with reference to FIGS. 13 to 14. It is to be noted that a configuration that is the same as or equivalent to a configuration described in the first embodiment is given the same reference character, and differences are mainly described.

FIG. 13 is a diagram similar to FIG. 3 and is a schematic diagram depicting a configuration of a compressed air system 320 according to the third embodiment. In the compressed air system 320 according to the present embodiment, an air compressor 321 is disposed instead of the air compressor 21. Further, a dryer 322 is disposed instead of the dryer 22, and a filter 324 is disposed instead of the filter 24. Moreover, in the compressed air system 320, a water separator 333, an exhaust heat recovery device 329, a discharged air pipe 331, and a water feed pipe 332 are additionally disposed.

The compressed air system 320 according to the present third embodiment is one example of a system anticipated to be selected in a case in which, as the air quality requested by the user, the oil total concentration in compressed air is the minimum (equivalent to class 0 as the highest class), the requested dewpoint is equal to or lower than −40 °C PDP (equivalent to class 2), and moreover an exhaust heat recovery device for intending to reduce the energy consumption of a user-side factory by use of exhaust heat of a compressor is requested.

In order to meet class 0 of the oil total concentration, an oil-free compressor is selected as the air compressor 321.

Further, in order to meet −40 °C PDP or lower (equivalent to class 2), an adsorption dryer (for example, heatless dryer) that can generate compressed air with a lower dewpoint than a general refrigeration dryer is selected as the dryer 322. The water separator 333 that removes surplus water such as condensed water is newly installed on the upstream side of the dryer 322. The water separator 333 prevents occurrence of a situation in which water droplets flow into the dryer 322 and the dewpoint deteriorates (dewpoint becomes higher). In addition, on the downstream side of the dryer 322, the filter 324 for removing minute particles of a tiny amount of adsorbent mixed in the compressed air that has passed through the dryer 322 is installed.

In this compressed air system 320, the exhaust heat recovery device 329 is connected to the air compressor 321.

The exhaust heat recovery device 329 executes heat exchange between a high temperature fluid such as high temperature compressed air and a low temperature fluid such as water on the user side to heat the water as the low temperature fluid.

That is, the exhaust heat recovery device 329 recovers exhaust heat of the air compressor 321 and heats the low temperature fluid. This provides hot water that can be used for other production facilities, air conditioning facilities, and the like on the user side.

The exhaust heat recovery device 329 can reduce electric power or fossil fuel for a boiler conventionally used for generating hot water. In a case in which an air-cooled compressor is employed as the air compressor 321, high temperature compressed air discharged from the air compressor 321 flows into a heat exchanger 330 for heat recovery in the exhaust heat recovery device 329 through the discharged air pipe 331. The high temperature compressed air is here subjected to heat exchange with water supplied from the user, to be cooled, and is refluxed into the air compressor 321 again. The refluxed compressed air is cooled to a predetermined air temperature by an air-cooling cooler that is not depicted but provided in the air compressor 321, and thereafter is discharged from the air pipe 25 toward the air reservoir 23. The water heated through the heat exchange by the heat exchanger 330 for heat recovery is supplied to a hot water demand destination on the user side by the water feed pipe 332.

FIG. 14 is a schematic diagram depicting a configuration example of an exhaust heat recovery device database 105. The exhaust heat recovery device database 105 is stored in the auxiliary storage unit 15 in the calculation device 11, as with the other databases. The exhaust heat recovery device database 105 stores information regarding an exhaust heat recovery device model C36, an air end lubrication system C37 of a corresponding compressor that corresponds to it, an applicable compressor output power zone C38, an initial cost C39, a rated exhaust heat recovery rate C40, a rated power consumption C41, and an average maintenance cost C42. The exhaust heat recovery device model C36 functions as a fluid equipment model identifier to identify the model (equipment type) of the exhaust heat recovery device 329.

In the present embodiment, the initial cost and the average maintenance cost of the exhaust heat recovery device 329 are added and are reflected in the air unit price C30 and the air unit price C31. The air unit price rises by the amount corresponding to the added costs. However, in general, the hot water generation cost that can be reduced through exhaust heat recovery is sufficiently higher than the amount of rise in the air unit price. Hence, a total cost benefit expected in introducing the exhaust heat recovery device 329 can be ensured.

The present third embodiment provides the following operation and effect.

(1) The compressed air system 320 (compressed gas system) can be connected to the exhaust heat recovery device 329 that recovers at least part of exhaust heat of the air compressor 321 (gas compressor) included in the compressed air system 320 (compressed gas system) and heats a low temperature fluid. Because this configuration is employed, the cost for generating hot water required by a demand destination of the user can be reduced.

The following modifications also fall within the scope of the present invention. It is also possible to combine a configuration depicted in a modification with a configuration described in one of the above-described embodiments, combine configurations described in different ones of the above-described embodiments with each other, or combine configurations described in the following different modifications with each other.

### Modification 1

In the above-described respective embodiments, the description has been given of the examples in which the present invention is applied to the fee calculation system suitable for the compressed air system. However, the present invention can be directed to an object other than the compressed air system that provides compressed air as compressed gas. For example, the present invention may be applied to a fee calculation system that executes fee calculation for a compressed nitrogen gas system that provides compressed nitrogen gas as compressed gas.

### Modification 2

In the above-described respective embodiments, the amount (concentration) of foreign matters, the water amount (water concentration), the oil total concentration, and the like are used as the quality parameters representing the quality requested of compressed air. However, naturally, it is also possible to apply the present invention to other quality parameters. For example, it is possible to employ any quality parameter such as the number of microorganisms contained in compressed air, as long as it is a parameter relating to the quality of the compressed air. Further, only some of the quality parameters explained in the above-described respective embodiments may be used.

While the embodiments of the present invention have been described above, the above-described embodiments merely depict some of application examples of the present invention and do not intend to limit the technical scope of the present invention to specific configurations of the above-described embodiments.

### DESCRIPTION OF REFERENCE CHARACTERS

10: Fee calculation system
11: Calculation device
20, 220, 320: Compressed air system (compressed gas system)
21, 321: Air compressor (gas compressor)
22: Dryer
23: Air reservoir
24, 324: Filter
30: Management terminal device
40: User terminal device
50: Network
101: Air compressor database
102: Filter database
103: Dryer database
104: Air reservoir database

1. A fee calculation system comprising:
a calculation device that calculates a usage fee of a compressed gas system,
wherein the calculation device is configured to
acquire a quality parameter representing quality of gas generated by the compressed gas system,
select constituent equipment of the compressed gas system on a basis of the acquired quality parameter,
calculate at least any expense among an initial expense of the compressed gas system, a maintenance expense in a predetermined period, and an operation expense in the predetermined period on a basis of the selected constituent equipment,
calculate a reference expense on a basis of a calculation result of the expense,
calculate a unit price of compressed gas generated by the compressed gas system, by dividing the reference expense by an amount of gas that can be supplied by the compressed gas system in a predetermined period,
calculate a usage fee of the compressed gas system on a basis of the calculated unit price of the compressed gas and an amount of use of the compressed gas, and
output the calculated unit price of the compressed gas and the calculated usage fee of the compressed gas system.

2. The fee calculation system according to claim 1, wherein the calculation device is configured to acquire, as the quality parameter, at least one of number of particles of foreign matters per unit gas amount, a mass concentration of foreign matters, a parameter representing a water amount per unit gas amount, and an oil total concentration.

3. The fee calculation system according to claim 1, wherein the calculation device is configured to calculate the amount of use of the compressed gas on a basis of a measurement value of a flow rate sensor disposed on a flow path of the compressed gas.

4. The fee calculation system according to claim 1, wherein the calculation device is configured to calculate the amount of use of the compressed gas on a basis of a load rate of a gas compressor included in the compressed gas system.

5. The fee calculation system according to claim 1, wherein the compressed gas system can be connected to an exhaust heat recovery device that recovers at least part of exhaust heat of a gas compressor included in the compressed gas system and heats a low temperature fluid.

6. The fee calculation system according to claim 1, wherein the calculation device is configured to output the unit price of the compressed gas and the usage fee of the compressed gas system to a display device or a terminal including the display device and cause the display device to display the unit price of the compressed gas and the usage fee of the compressed gas system.

7. A fee calculation method comprising:
acquiring a quality parameter representing quality of gas generated by a compressed gas system;
selecting constituent equipment of the compressed gas system on a basis of the acquired quality parameter;
calculating at least any expense among an initial expense of the compressed gas system, a maintenance expense in a predetermined period, and an operation expense in the predetermined period on a basis of the selected constituent equipment ;
calculating a reference expense on a basis of a calculation result of the expense;
calculating a unit price of compressed gas generated by the compressed gas system, by dividing the reference expense by an amount of gas that can be supplied by the compressed gas system in a predetermined period;
calculating a usage fee of the compressed gas system on a basis of the calculated unit price of the compressed gas and an amount of use of the compressed gas; and
outputting the calculated unit price of the compressed gas and the calculated usage fee of the compressed gas system.
